(19) United States
(12) Patent Application Publication
(10) Pub. No.: US 2018/0315330 A1
(43) Pub. Date: Nov. 1, 2018

(54) LEARNING EVENT MANAGEMENT SYSTEM

(71) Applicant: edX Inc., Cambridge, MA (US)

(72) Inventor: Piotr F. Mitros, Cambridge, MA (US)

(21) Appl. No.: 15/966,490

(22) Filed: Apr. 30, 2018

Related U.S. Application Data
(60) Provisional application No. 62/491,547, filed on Apr. 28, 2017.

(51) Int. Cl. G09B 5/12; H04L 29/08; G06F 15/18

(52) U.S. Cl. CPC G09B 5/12; G06F 15/18; H04L 67/22

(57) ABSTRACT

A method for processing learning events in a learning management system includes receiving a number of learning events at the learning management system, processing the number of learning events in a number of processing pipelines to generate learning analytics, wherein at least some of the processing pipelines are configured according to one or more processing constraints, the processing constraints including one or more of temporal constraints, learning event ordering constraints, and computational resource constraints, and adjusting a behavior of the learning management system based on the generated learning analytics.

### CROSS-REFERENCE TO RELATED APPLICATIONS

This application claims the benefit of Provisional Application Ser. No. 62/491,547, filed Apr. 28, 2017, the contents of which are hereby entirely incorporated herein by reference.

### BACKGROUND

This invention relates to management of learning events in a learning record store in a learning management system.

Learning management systems administer, document, track, report, and deliver electronic educational courses or training programs to users. Some learning management systems include thousands of electronic educational courses which are administered to millions of users.

### SUMMARY

Learning management systems provide their users with access to formal online educational courses (e-learning courses). Very generally, e-learning courses present content to users (e.g., problems, simulations, educational games, interactives, audiovisual content, audio content, video content, textual content, etc.) and receive feedback from users (e.g., answers to test questions, written essays, scrubs through a video, etc.). Users can also interact with one another, professors, administrators and so on through environments such as online discussion forums. Each of a user's interactions with a learning management system, (e.g., watching a video, answering a test question, interacting with another user) is referred to as a ‘learning event.’

While many learning events occur within the environment of a learning management system, learning events can also occur in many other environments outside of the learning management system. For example, mentoring someone, writing a blog post, or reading a book are learning events which do not necessarily require a learning management system.

Learning events are generally captured from a user's interactions with one or more computing devices and the captured learning events are transmitted via one or more networks (e.g., the internet, a local area network, and/or a cellular network) to a server associated with a learning management system where they are stored in a centralized learning record data store (“learning record store”). By storing learning events for a user, rich information such as the user's learning style and learning progress can be ascertained. This information can be used to enhance the user's learning experience through features such as hinting and gamification of the learning experience.

Learning event pipelines, despite the similarity in name to, for example, server event pipelines, are quite different in goals and architectures, due in part to the real-time nature of learning events, and in part, due to the high-stakes nature of some learning events. Log server events are generally used for post-hoc analysis for business intelligence or failure diagnostics. In contrast, learning events feed into learning analytics systems which drive real-time decisions with long-term repercussions. For example, learning analytics systems may visualize to learners when the system estimates the user has mastered a concept (gamification), visualize for instructors what common student misconceptions are (real-time formative feedback, as in classroom response systems), visualize conversations happening in a social learning system in a classroom, detect and pull incorrect problems from assignments in real time (item response theory), flag failing students, and a range of similar functions. Such functions require learning analytics systems to be able to process data in tens of milliseconds to single-digit seconds. Learning analytics systems will often have slower, parallel pipelines used for providing insights which lead to overall courseware improvements, both in platform and content. For example, they may show the last activity which a learner engaged in before dropping out, provide histograms of where students spend time, or provide estimates of difficulty. Such pipelines operate at a range of speeds, from hours, to days, to once-per-semester, to ad-hoc analysis. Learning events are often used to estimate student skill, and in other high-stakes tasks which may have a long-term impact on learners' lives. If a student answers a problem incorrectly five times, and correctly on the sixth try, if a learning record store were to drop the final event, the system would have a grossly incorrect estimate of that student's knowledge, and in some systems, and incorrect grade for that student.

However, given the state of modern computing, continuous network connectivity between computing devices and the server associated with the learning management system is not guaranteed. For example, a cable internet connection being utilized by a personal computer may be interrupted during a storm or a cellular network connection being utilized by a smart phone may be interrupted when the smart phone enters a subway tunnel. If a user is generating learning events using one or more computing devices during loss of network connectivity for the one or more computing devices, the generated learning events may be lost or may be received in an incorrect order at the server associated with the learning management system. Such a loss of information may be detrimental to the operation of the learning management system, or to analytics performed about actions within such a system.

The possibility of the above-described loss of information is a technological problem that has arisen from the internet and the new technology of online learning management systems. Aspects described herein provide a specific technological solution to this technological problem by processing learning events in such a way that loss of information is mitigated. This mitigating of loss of information is a clear improvement to the technological process of online learning management system administration.

The problem of loss of information, including loss of learning events, is arises in the realm of online learning management system administration, where the distributed online nature of the system opens learning opportunities to significantly more students, especially those who are geographically distributed and therefore must participate over a network connection. Aspects described herein are necessarily rooted in computer technology to overcome the problem, arising in the technological realm of online learning management systems, of loss of information. By processing learning events in processing pipelines, aspects mitigate loss of information in the online learning management system. Without being rooted in computer technology, it would be infeasible to process the large number of learning events that occur in the online learning management system.

Aspects described herein provide mechanisms for ensuring that substantially all learning events generated by a user, across the user's computing devices, are captured in chronological order, even in the presence of loss of network connectivity at one or more of the user's computing devices.

In a general aspect, a method for processing learning events in a learning management system includes receiving a number of learning events at the learning management system, processing the number of learning events in a number of processing pipelines to generate learning analytics, wherein at least some of the processing pipelines are configured according to one or more processing constraints, the processing constraints including one or more of temporal constraints, learning event ordering constraints, and computational resource constraints, and adjusting a behavior of the learning management system based on the generated learning analytics.

Aspects may include one or more of the following features.

At least some of the learning events may be received out of order. A processing pipeline of the number of processing pipelines may process the at least some of the learning events in the order in which they are received. A processing pipeline of the number of processing pipelines may reorder the at least some of the learning events prior to processing the at least some of the learning events. The reordering may include waiting for missing messages to be received. The computational resource constraints may specify that received learning events are provided to different processing pipelines of the number of processing pipelines based on expected computational requirements associated with the learning events.

The computational resource constraints may specify that the received learning events are provided to different processing pipelines of the number of processing pipelines based on a computational load of the processing pipelines. The one or more temporal constraints may specify that at least some of the processing pipelines execute periodically. The one or more temporal constraints may specify that at least some of the processing pipelines execute on request. At least some of the processing pipelines may execute when a predetermined number of learning events are received at the processing pipelines. At least some of the processing pipelines may process learning events immediately upon arrival of the learning events. At least some of the processing pipelines may be associated with a reliability constraint. The reliability constraint may specify a number of learning events that can be left unprocessed by the at least some processing pipelines.

In another general aspect, a method for processing learning events in a learning management system, the learning events being transmitted from a number of user devices to the learning management system, at least some of the user devices having intermittent connectivity to the learning management system, includes receiving the learning events at the learning event management system, wherein at least some of the learning events were aggregated by a user device while the user device was disconnected from the learning management system and were subsequently transmitted to the learning management system when the user device re-established connectivity with the learning management system, updating one or more learning analytics models associated with the learning management system based on the received learning events, including updating at least some of the one or more learning analytics models based at least in part on the at least some of the learning events that were aggregated by a user device while the user device was disconnected from the learning management system and were subsequently transmitted to the learning management system when the user device re-established connectivity with the learning management system.

Aspects may have one or more of the following advantages.

Among other advantages, aspects prevent loss of learning events due to loss of network connectivity. This loss prevention results in more complete learning information for users and an overall improved operation of the learning management system.

Aspects ensure that learning events generated from multiple computing devices are maintained in such a way that their order of generation can be determined, even in the event of a loss of connectivity for one or more of the computing devices.

This permits better estimation of learner's level of ability on specific skills, enables use of more advanced psychometric techniques on learner data, more adaptive content, better integration of adaptive and non-adaptive content, and allows better integration of data from multiple devices.

Other features and advantages of the invention are apparent from the following description, and from the claims.

### DESCRIPTION OF DRAWINGS

FIG. 1 is a learning management system in communication with a number of computing devices over one or more networks.

FIG. 2 shows the learning management system storing records for first and second learning events.

FIG. 3 shows a first user generating a third learning event.

FIG. 4 shows the learning management system storing a record for the third learning event.

FIG. 5 shows a second user generating a fourth learning event.

FIG. 6 shows the learning management system storing a record for the fourth learning event.

FIG. 7 shows the first user generating fifth, sixth, and seventh learning events.

FIG. 8 shows the learning management system storing a record for the sixth learning event.

FIG. 9 shows the second user generating an eighth learning event.

FIG. 10 shows the learning management system storing a record for the eighth learning event.

FIG. 11 shows the learning event cache sending the fifth and seventh learning events to the learning management system upon restoration of network connectivity.

FIG. 12 shows the learning management system storing records for the fifth and seventh learning events.

FIG. 13 is a learning event processor of the learning management system of FIG. 1.

### DESCRIPTION

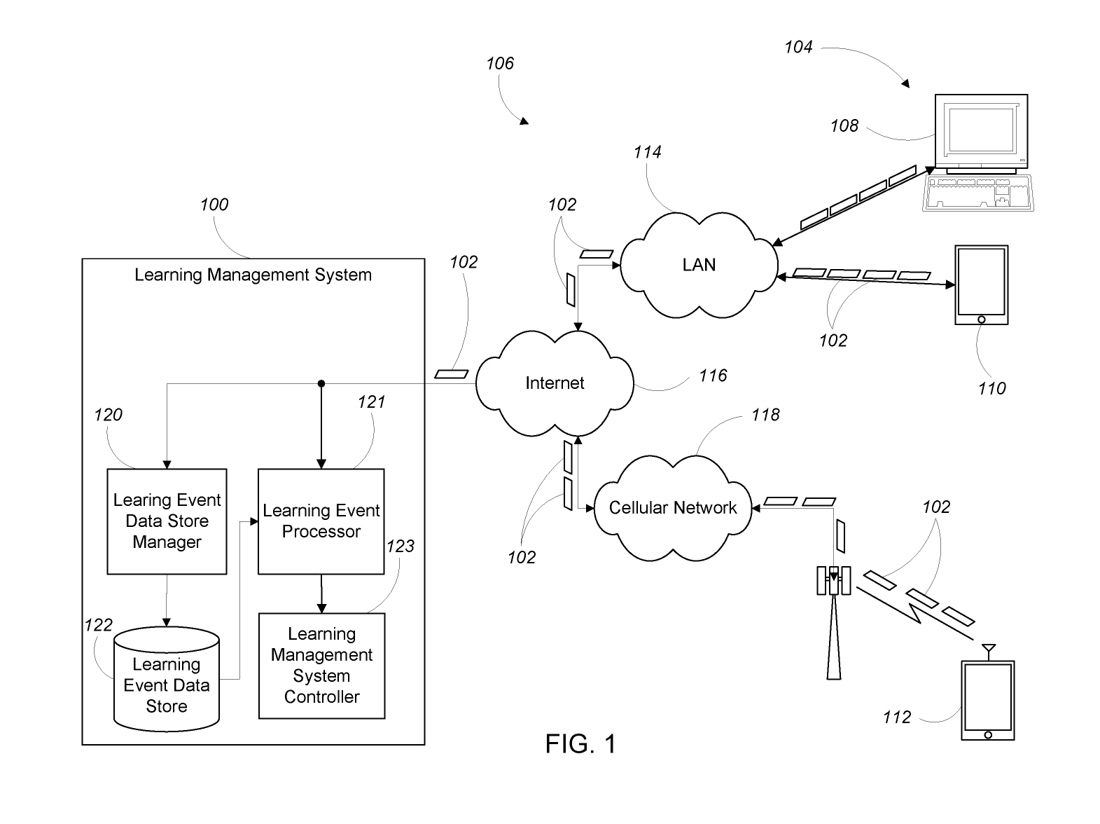

Referring to FIG. 1, a learning management system 100 receives a number of learning events 102 via one or more network connections 106. In some examples, the one or more learning events are generated by users (not shown) operating one or more computing devices 104. The computing devices 104 may include any suitable network-connectable computing device capable of user interaction. In the example of FIG. 1, the computing devices 104 include a personal computer 108, a tablet computer 110, and a cellular device 112.

Upon interaction with users, the computing devices 104 generate the learning events 102 and provide them to the learning management system 106 via the one or more network connections 106. In FIG. 1, the personal computer 108 provides learning events 102 to the learning management system 100 via a local area network (LAN) 114 and the internet 116. The tablet computer 110 provides learning events 102 to the learning management system 100 via the local area network (LAN) 114 and the internet 116. The cellular device 112 provides learning events 102 to the learning management system 100 via a cellular network 118 and the internet 116.

The learning management system 100 includes, among other features, a learning record store manager 120, a learning record store 122, a learning event processor 121, and a learning management system controller 123. As is described in detail below, learning events 102 that are received by the learning management system 100 are provided to the learning record store manager 120 which stores records of the learning events 102 in the learning record store 122. Learning events 102 that are received by the learning management system 100 are also provided to the learning event processor 121, along with learning events 102 from the learning record store 122. As is described in greater detail below, the learning event processor 121 processes the learning events 102 in one or more processing pipelines (not shown) to generate learning event analytics, which are provided to the learning management system controller 123. The learning management system controller 123 configures the learning management system 100 based on the learning event analytics generated by the learning event processor 121.

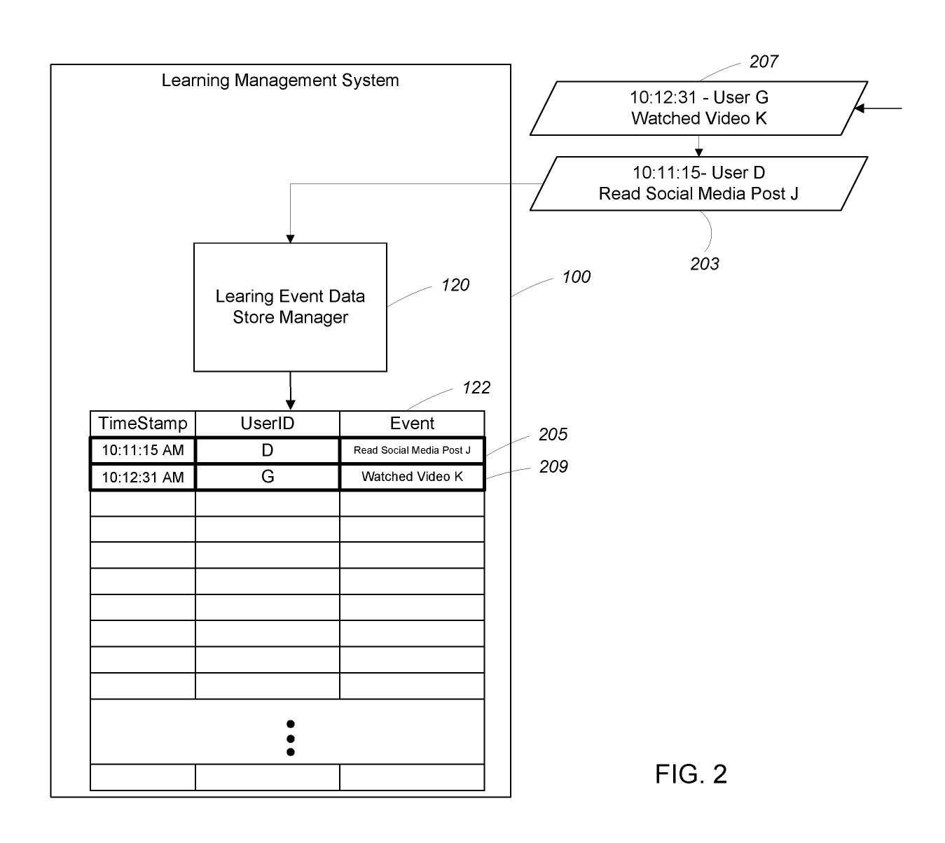

Referring to FIG. 2, in a simple operational example of the learning management system 100, a first learning event 203 and a second learning event 207 are received at the learning management system 100. The first learning event 203 indicates that user D read social media post J at 10:11:15 AM. The second learning event 207 indicates that user G watched video K at 10:12:31 AM. The learning record store manager 122 receives the first learning event 203 and stores a first record 205 corresponding to the first learning event 203 in the learning record store 122. The learning record store manager 122 then receives the second learning event 207 and stores a second record 209 corresponding to the second learning event 207 in the learning record store 122. Since the second learning event 207 occurred after the first learning event 203, the second record 209 is stored after the first record 205 (i.e., in chronological order) in the learning record store 122. In some examples, when records of learning events are time stamped, the chronological order may be maintained by having a data structure which indexes into the learning record store into chronological order, rather maintaining the events in chronological order in memory.

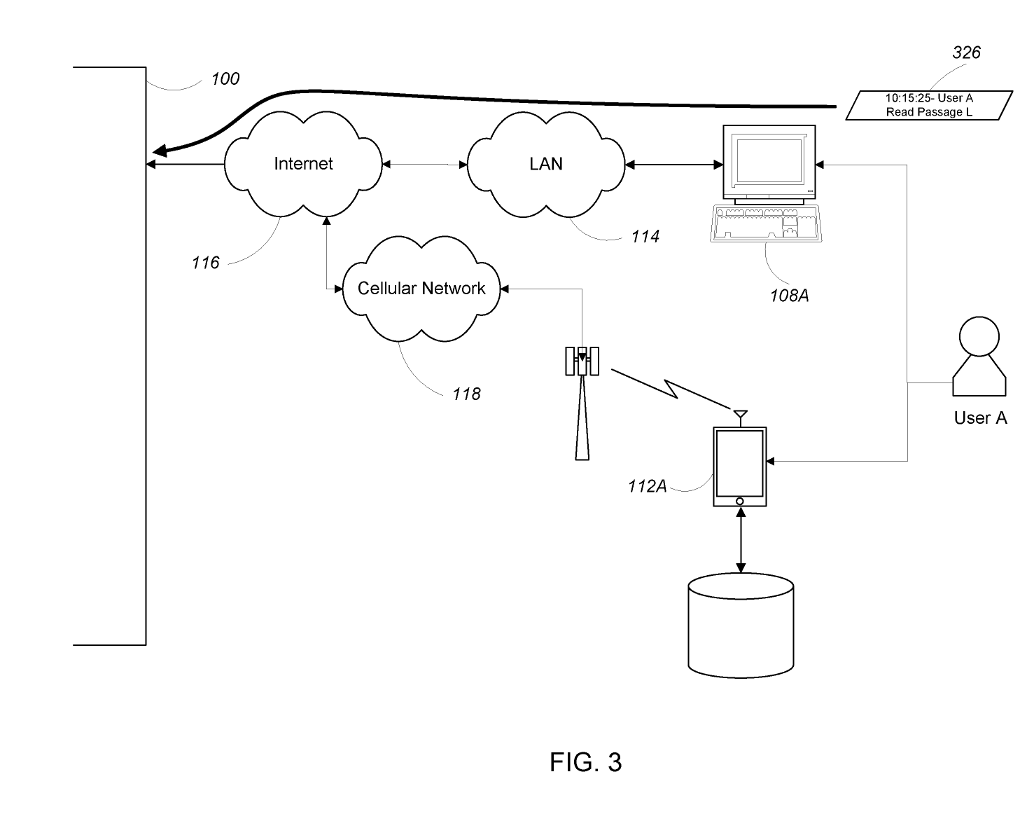

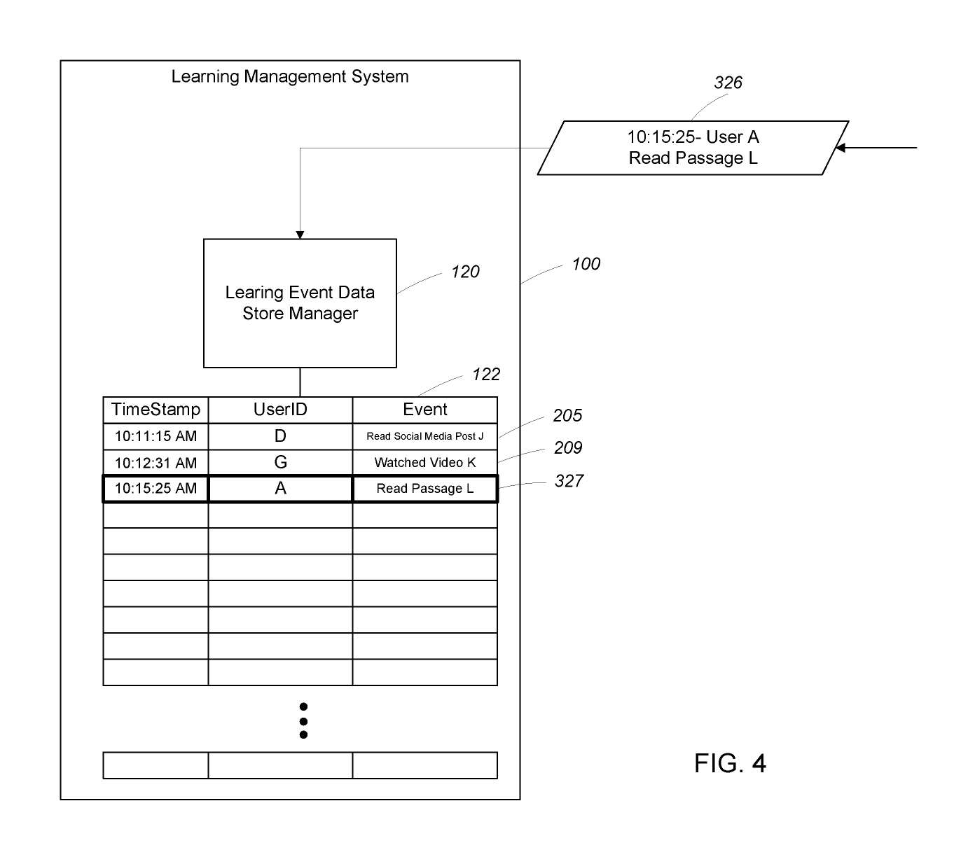

Referring to FIG. 3, a user, user A, interacts with the learning management system 100 via a personal computer 108A and a cellular device 112A. In FIG. 3, user A reads passage L using the personal computer 108A. When user A completes reading passage L, the personal computer 108A generates a third learning event 326 indicating that user A completed reading passage L at 10:15:25 AM. The personal computer 108A sends the third learning event 326 to the learning management system 100 via the LAN 114 and the internet 116. Referring to FIG. 4, upon receiving the third learning event 326, the learning record store manager 120 determines that the third learning event 326 occurred after the second learning event 207 and therefore stores a third record 327 corresponding to the third learning event 326 immediately after the second record 209 of the second learning event 207 in the learning record store 122.

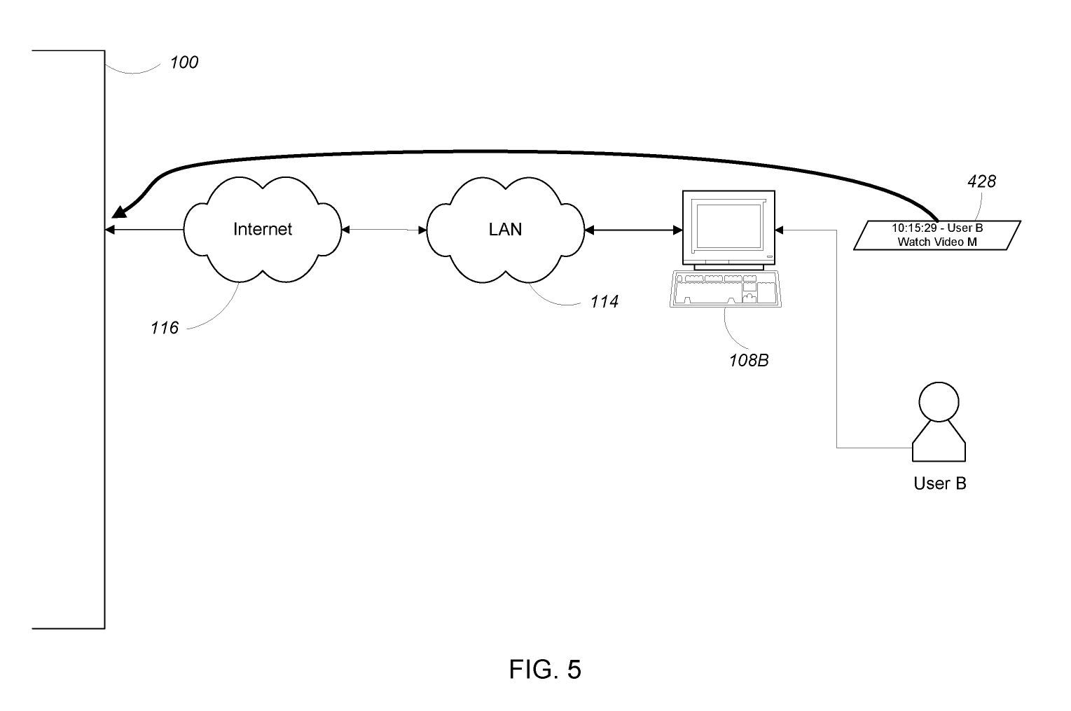

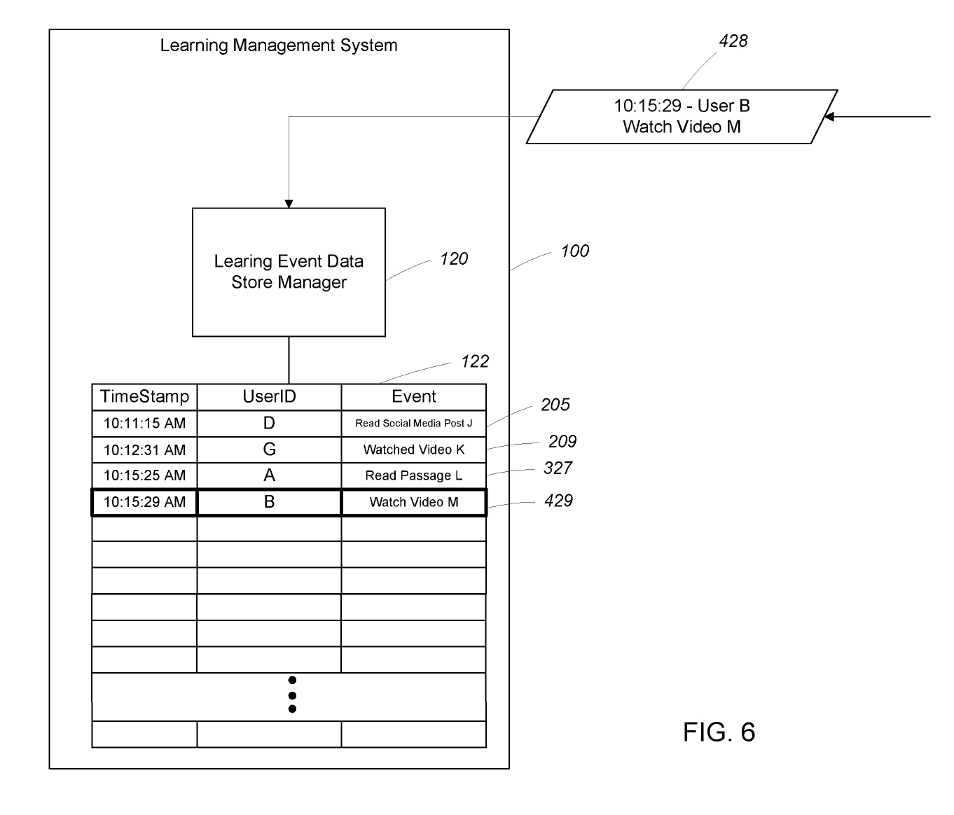

Referring to FIG. 5, another user, user B interacts with the learning management system 100 via a personal computer 108B. In FIG. 5, user B watches video M using the personal computer 108B. When user B completes watching video M, the personal computer 108B generates a fourth learning event 428 indicating that user B completed watching video Mat 10:15:29 AM. The personal computer 108B sends the fourth learning event 428 to the learning management system 100 via the LAN 114 and the internet 116. Referring to FIG. 6, upon receiving the fourth learning event 428, the learning record store manager 120 determines that the fourth learning event 428 occurred after the third learning event 326 and therefore stores a fourth record 429 corresponding to the fourth learning event 428 immediately after the third record 327 of the third learning event 326 in the learning record store 122.

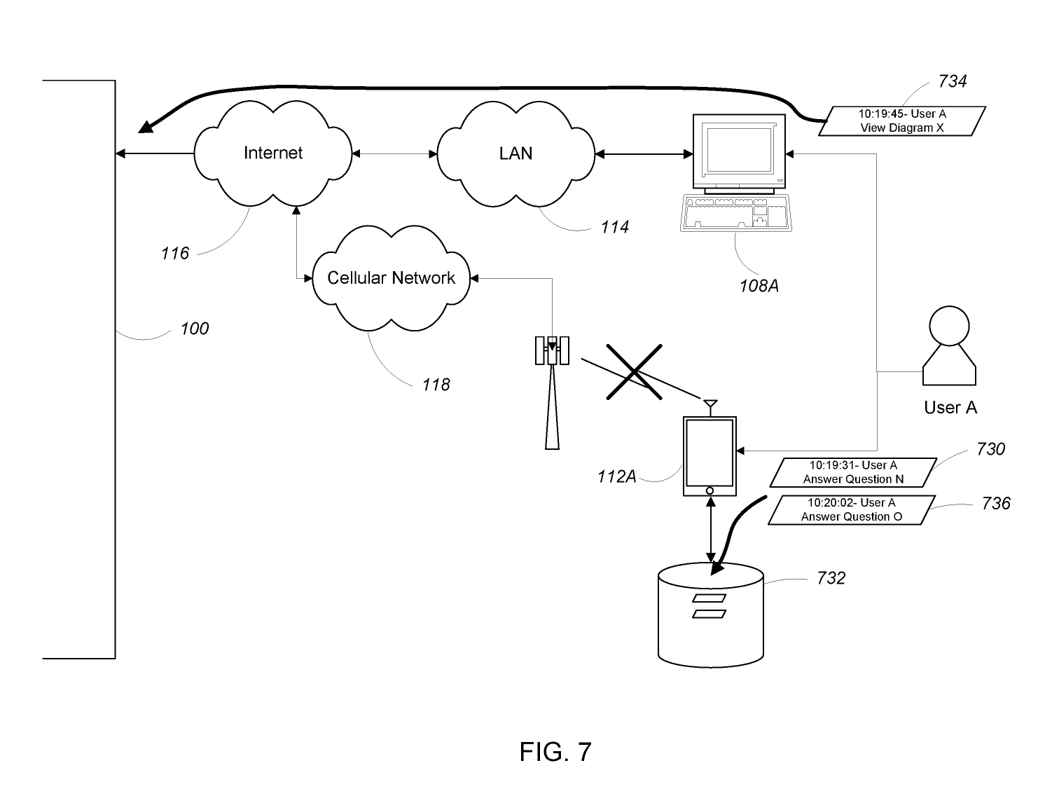

Referring to FIG. 7, user A again interacts with the learning management system 100. First, user A answers question N using the cellular device 112A, resulting in the cellular device 112A generating a fifth learning event 730 indicating that user A answered question N at 10:19:31 AM.

When the cellular device 112A attempts to send the fifth learning event 730 to the learning management system 100 via the cellular network 118, it fails due to a lack of connectivity between the cellular network 118 and the cellular device 112A (e.g., due to the cellular device 112A being in a subway tunnel or otherwise out of range of a cellular communication tower). Rather than discarding the fifth learning event 730, the cellular device 112A stores the fifth learning event 730 in a learning event cache 732 of the cellular device 112A until network connectivity is restored between the cellular network 118 and the cellular device 112A.

User A then views diagram X using the personal computer 108A. When user A completes viewing diagram X, the personal computer 108A generates a sixth learning event 734 indicating that user A viewed diagram X at 10:19:45 AM. The personal computer 108A sends the sixth learning event 734 to the learning management system 100 via the LAN 114 and the internet 116.

User A then answers question 0 using the cellular device 112A, resulting in the cellular device 112A generating a seventh learning event 736 indicating that user A answered question O at 10:20:02 AM.

As was the case with the fifth learning event 730, when the cellular device 112A attempts to send the seventh learning event 736 to the learning management system 100 via the cellular network 118, it fails due to a lack of connectivity between the cellular network 118 and the cellular device 112A. Rather than discarding the seventh learning event 736, the cellular device 112A stores the seventh learning event 736 in the learning event cache 732 until network connectivity is restored between the cellular network 118 and the cellular device 112A.

By storing the fifth learning event 730 and the seventh learning event 736 in the learning event cache 732 rather than simply discarding the learning events, loss of important learning information is prevented.

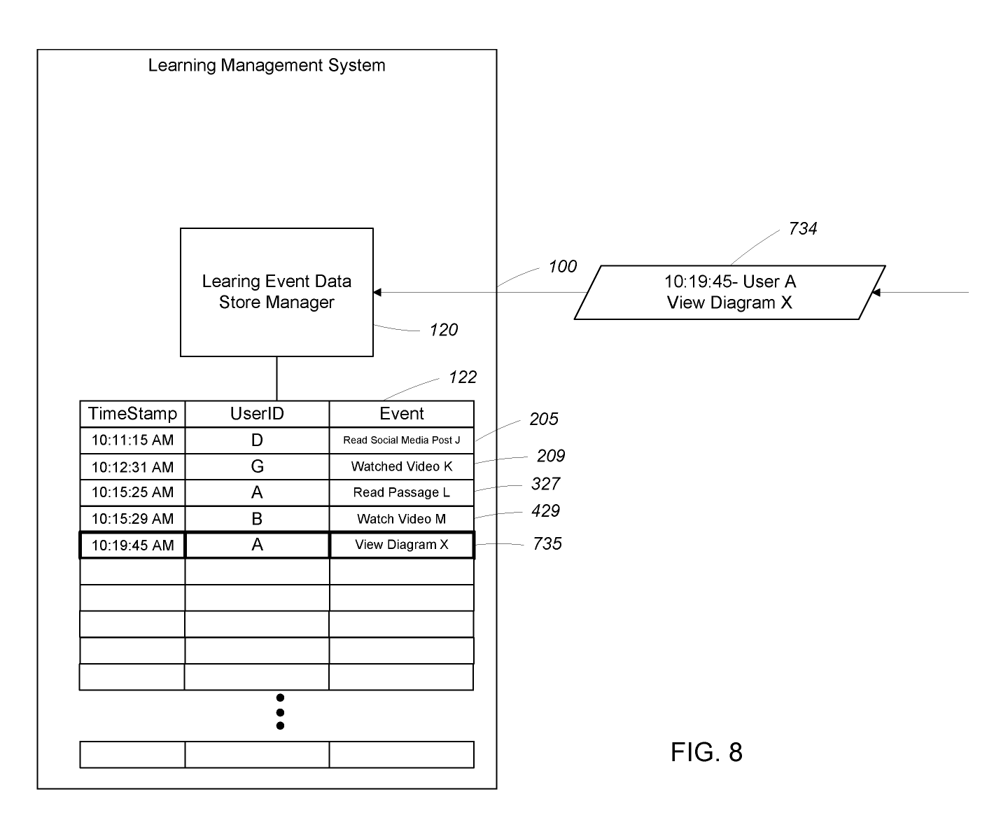

Referring to FIG. 8, upon receiving the sixth learning event 734, the learning record store manager 120 determines that the sixth learning event 734 occurred after the fourth learning event 428 and therefore stores a sixth record 735 corresponding to the sixth learning event 734 immediately after the fourth record 429 of the fourth learning event 428 in the learning record store 122.

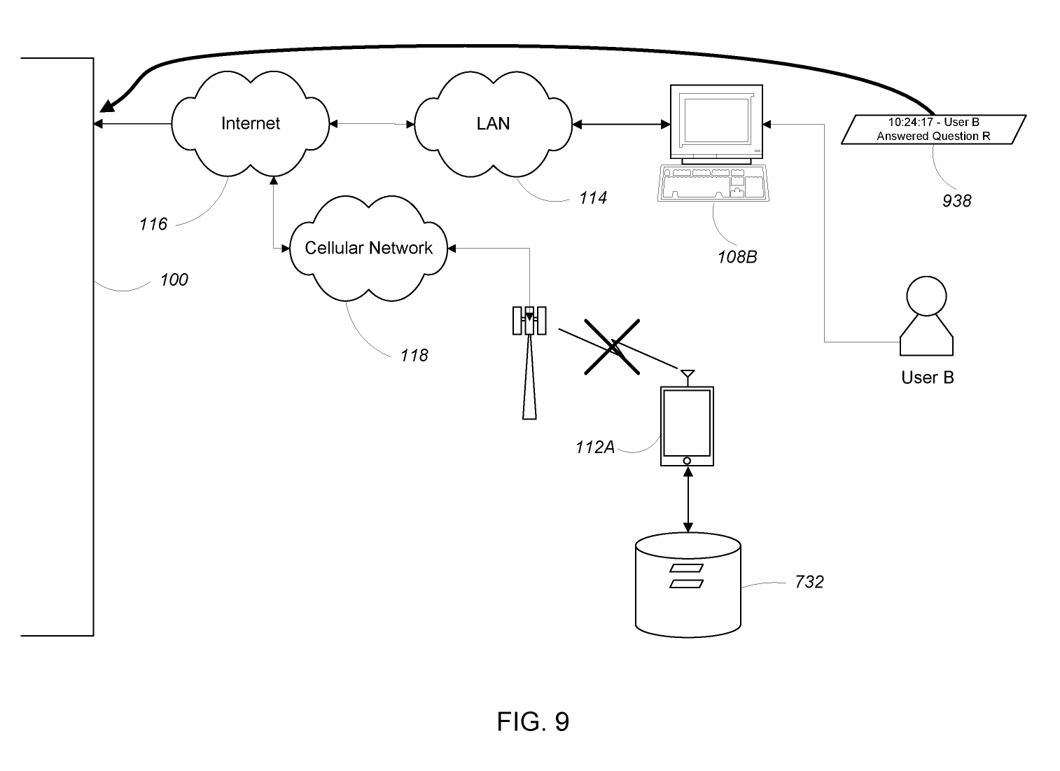

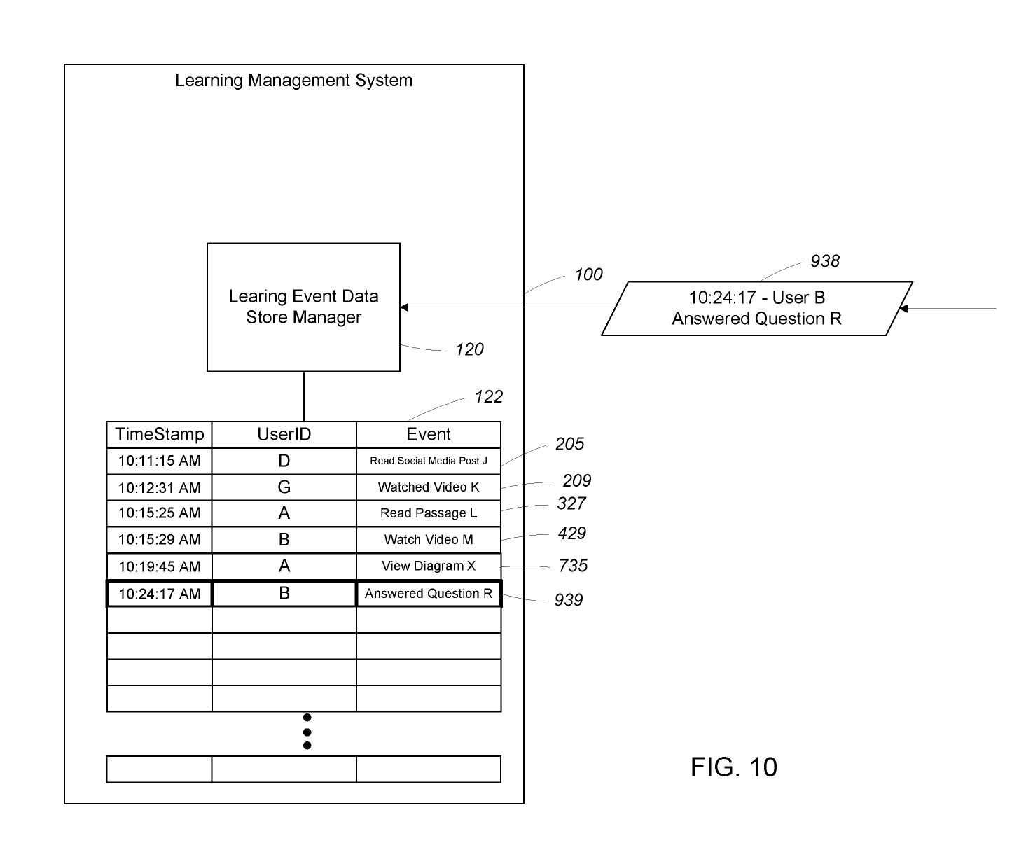

Referring to FIG. 9, while the network connectivity is still disrupted for user A's cellular device 112A, user B interacts with the learning management system 100 by answering question R at 10:24:17 AM using the personal computer 108B. User B's interaction results in the personal computer 108B generating an eighth learning event 938 indicating that user B answered question R at 10:24:17 AM. The personal computer 108B sends the eighth learning event 938 to the learning management system 100 via the LAN 114 and the internet 116. Referring to FIG. 10, upon receiving the eighth learning event 938, the learning record store manager 120 determines that the eighth learning event 938 occurred after the sixth learning event 734 and therefore stores an eighth record 939 corresponding to the eighth learning event 428 immediately after the sixth record 735 of the sixth learning event 734 in the learning record store 122.

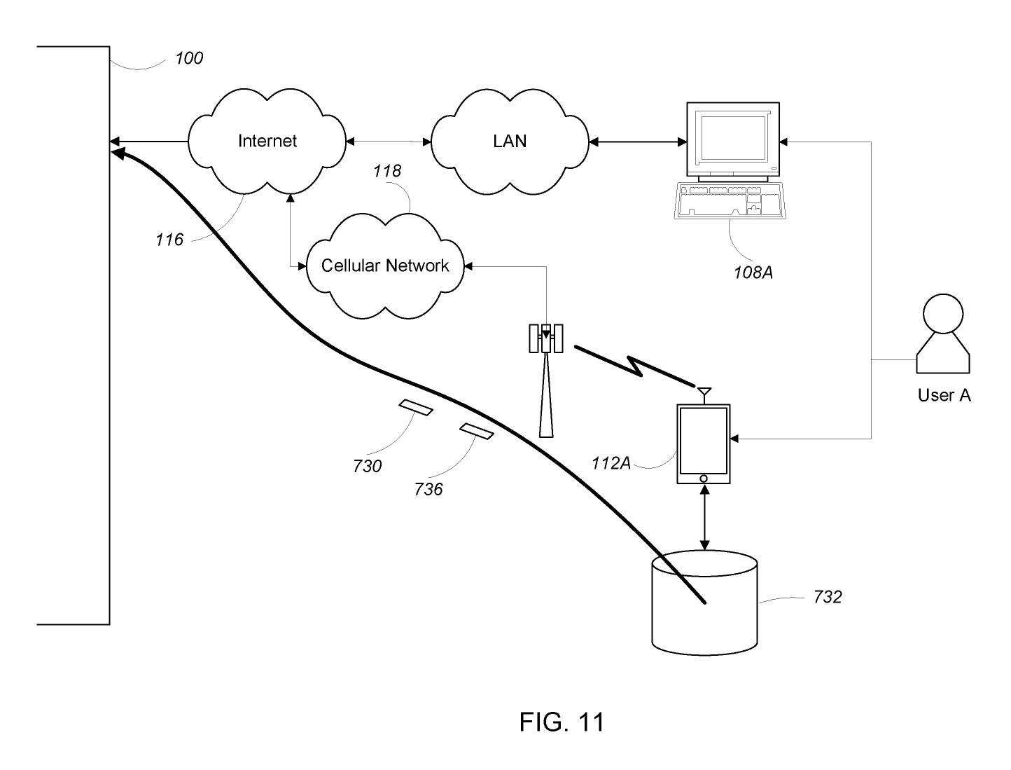

Referring to FIG. 11, at some time after the sixth record 735 is written to the learning record store 122, network connectivity between user A's cellular device 112A and the learning management system 100 is restored. With network connectivity restored, the cellular device 112A determines that its learning event cache 732 has stored learning events (i.e., the fifth learning event 730 and the seventh learning event 736). The cellular device 112A sends the fifth learning event 730 and the seventh learning event 736 to the learning management system 100 via the cellular network 118 and the internet 116.

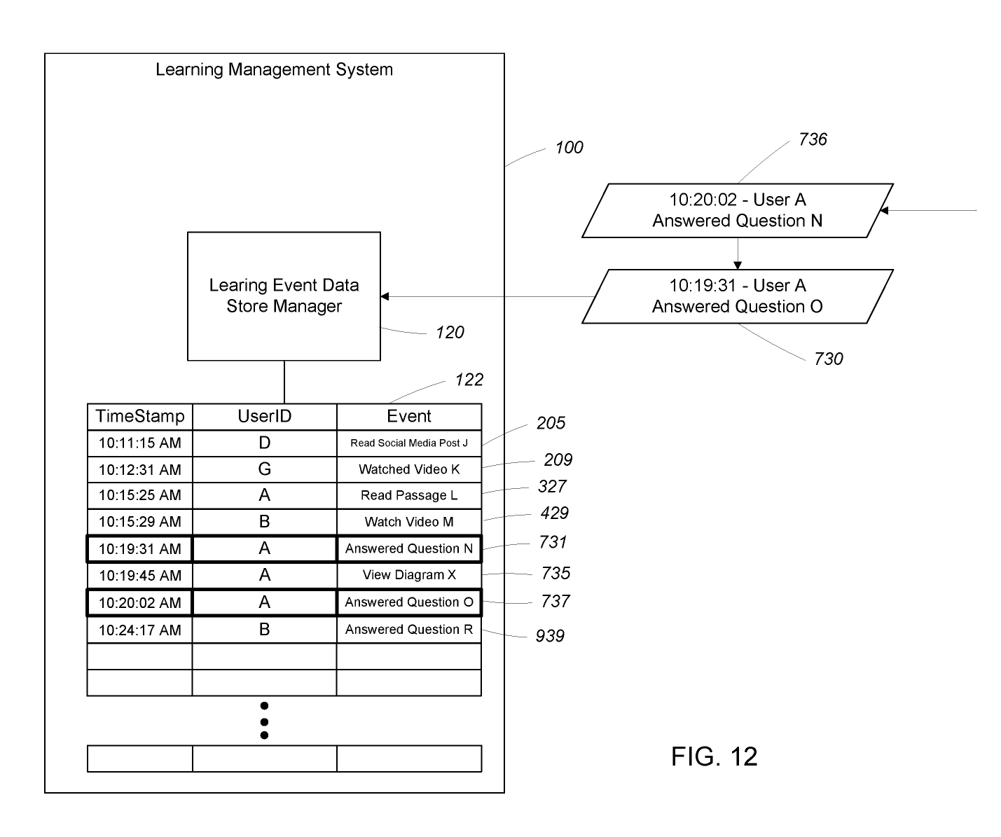

Referring to FIG. 12, when the fifth learning event 730 is received at the learning management system 100, the learning record store manager 120 examines the records in the learning record stores 122 and determines that the fifth learning event 730 occurred after the fourth learning event 428 and before the sixth learning event 734, even though the fifth learning event 730 was received by the learning management system 100 well after both the fourth and sixth learning events. Thus, the learning record store manager 120 inserts a fifth record 731 corresponding to the fifth learning event 730 between the fourth record 429 and the sixth record 735.

When the seventh learning event 736 is received at the learning management system 100, the learning record store manager 120 examines the records in the learning record store 122 and determines that the seventh learning event 736 occurred after the sixth learning event 734 and before the eighth learning event 938, even though the seventh learning event 736 was received by the learning management system 100 well after both the sixth and eighth learning events. Thus, the learning record store manager 120 inserts a seventh record 737 corresponding to the seventh learning event 736 between the sixth record 735 and the eighth record 939.

In the examples described above, only the cellular device is described as having a learning event cache. However, it is noted that any of the computing devices can be configured to include a learning event cache.

Learning Event Processing

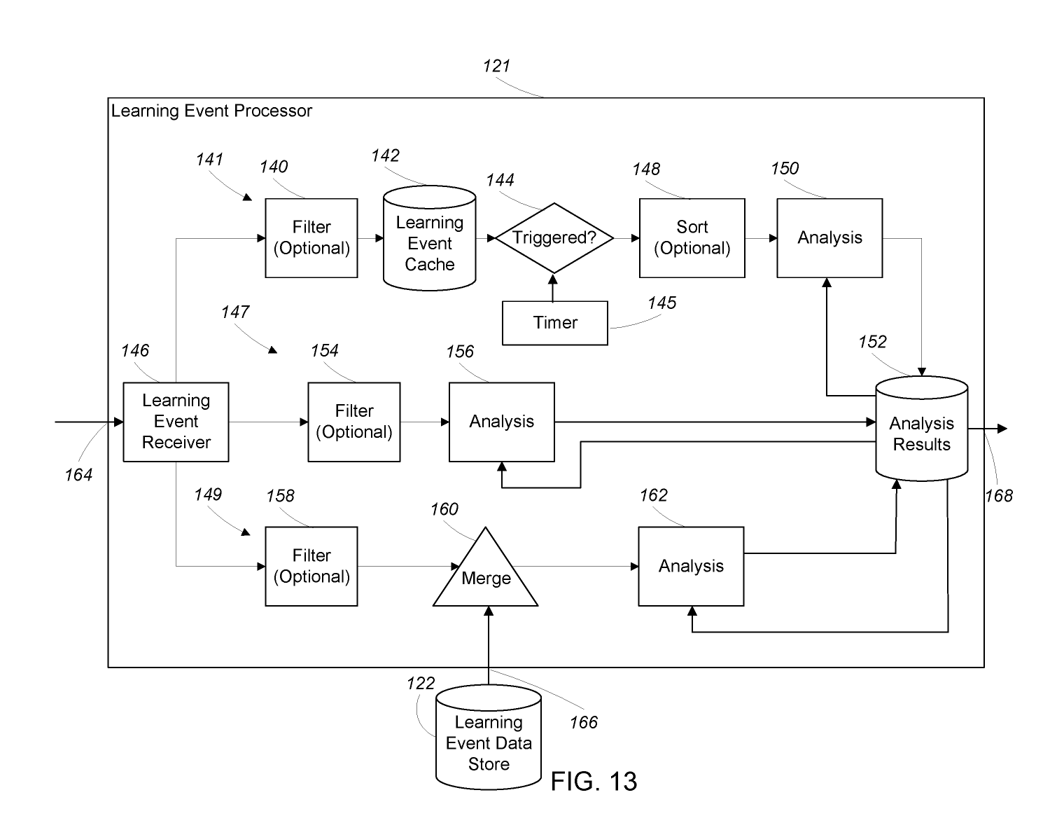

Referring to FIG. 13, in addition to storing learning events, the learning management system 100 processes learning events. As is noted above, this processing is performed by a learning event processor 121. The learning event processor 121 has a first input 164 for receiving newly arrived learning events a second input 166 for receiving stored learning events from the learning event data store 122. The learning event processor 121 processes the learning events received from the first input 164 and/or the second input 166 to generate analysis results. The analysis results generated by the learning event processor 121 are provided to the learning management system controller 123 via an output 168 and/or stored in an analysis results data store 152.

In some examples, the processing of learning events is accomplished using a series of steps sometimes referred to as a “processing pipeline.” In general, processing pipelines are associated with certain constraints such as latency constraints and/or computational resource constraints. For example, some processing pipelines require that a learning event is processed within a single web request. In such cases, the response time needs to be on the order of 30 milliseconds or less to ensure that a user does not perceive a latency (e.g., from the start of a web request to the end of the web request). Due to the differing constraints on processing pipelines, a single learning event processor 121 may include two or more processing pipelines processing learning events in parallel.

For example, the learning event processor 121 of FIG. 13 includes a first processing pipeline 141, a second processing pipeline 147, and a third processing pipeline 149 for processing learning events in parallel. A learning event receiver 146 receives newly arrived learning events and, based on certain characteristics of the learning events, distributes the learning events to some or all of the processing pipelines.

Very generally, each of the processing pipelines receives learning events from the learning event receiver 146, processes the learning events in an analysis module which generates analysis results. In some examples, the analysis module of a given pipeline includes one or more learning event handlers, each of which processes learning events using learning event analysis algorithms (e.g., generating histograms of video usage patterns, Baysian Knowledge Tracing, item response theory, dropout prediction using algorithms such as deep learning, word cloud visualizations of forum usage, time-on-task algorithms, etc.). The learning event analysis algorithms generate the analysis results.

However, different pipelines may include additional features that adapt the simple processing pipeline model described above to accommodate processing constraints associated with the processing pipelines.

For example, in FIG. 13, the first pipeline 141 is configured to periodically process new learning events. When the learning event receiver 146 provides a new event to the first pipeline 141, the event is (optionally) provided to a first event filter 140 which filters for events relevant to downstream event handlers. The optionally filtered learning event is then stored in a learning event data cache 142 (e.g. a daily cache). When a timer module 145 (e.g. a timer that triggers every day at midnight or a timer that triggers when computational capacity is available and/or inexpensive) triggers, the learning events stored in the learning event data cache 142 are released in bulk to to downstream modules in the first processing pipeline 141. The released learning events are optionally be sorted by a sorting module 148 prior to being provided to a first analysis module 150. At that point, they are handled by an event handler associated with the first analysis module 150. The results of processing events in the first analysis module 150 are provided to the output 168.

The second pipeline 147 is configured to process learning events immediately upon reception. When the learning event receiver 146 provides a new event to the second pipeline 147, the event is (optionally) provided to a second event filter 154 which filters for events relevant to downstream event handlers. The filtered learning events are provided (likely out of order) to a second analysis module 156. At that point, they are handled by one or more event handlers associated with the second analysis module 156. The results of processing events in the second analysis module 156 are provided to the output 168.

The third pipeline 149 is configured to ensure that learning events are processed in order. In particular, when the learning event receiver 146 provides a set of one or more learning events to the third pipeline 149, the event is (optionally) provided to a third event filter 158 which filters for events relevant to downstream event handlers. If the learning events are received in order, they are transferred directly to a third analysis module 162 where they are handled by one or more event handlers associated with the third analysis module 162. Otherwise, if the set of one or more events includes any learning events that predate any learning events stored in the learning event data store 122, the events are merge-sorted with all events in the learning record store 122 more recent than the oldest event in the set of newly received learning events. The merge-sorting is accomplished by using a merge-sorting module 160. The merge-sorted learning events are provided to the third analysis module 162 which processes the learning events (in bulk) using one or more event handlers associated with the third analysis module.

Of course, may other types of processing pipelines are possible. For example, some processing pipelines generate analysis results that are used by the learning management system controller 123 for adaptivity. Such processing pipelines require that analysis results are presented immediately after a given task (e.g., in-class formative assessment/classroom response systems, gamification—such as giving a visual indicator when a student masters a concept, remediation in response to a submission, determining the next task in an intelligent tutoring system,) is finished. Yet other processing pipelines are required to complete processing of learning events within a time range from a few hundred milliseconds to a few seconds. For example, classroom response systems must process learning events to present formative feedback to students or instructors within such a timeframe.

In some examples, processing pipelines are required to complete processing of learning events on a time scale that ensures that analysis results are available to the learning management system controller 123 as formative feedback for driving the design of in-class activities. For example, students may work through a homework assignment or survey one evening, driving the design of an in-class activity. In such a case, many hours of delay before the processing pipeline generates analysis results is often adequate. In some examples, processing pipelines are required to complete processing of learning events on a time scale the ensures that semester-to-semester feedback is provided in a timely manner, for example, to improve course design, or to drive recommendations for future courses.

In some examples, the frequency of execution of certain processing pipelines is dependent on student activity. One example of such an event processing pipeline includes an item response theory event processing algorithm for detection of bad problems in an online assignment. The item response theory event processing algorithm is an expensive optimization algorithm, and is only weakly dependent on number of submissions (i.e., learning events) received. Consequently, the processing pipeline may only perform the item response theory event processing algorithm at specific thresholds on a number of received submissions (for example, once the number of submissions has grown exponentially, so at 5, 10, 20, 40, 80, 160, etc. submissions).

Some processing pipelines execute in an on-demand manner. For example, an instructor of an online course may request statistics for a particular demographic of students. Due to the exponentially large number of possible requests, this may not make sense to preemptively execute the processing pipeline. The processing results may be delivered synchronously or asynchronously. In some examples, hybrid techniques are employed. For example, a processing pipeline may be required to run a full item response theory event processing algorithm (as described above), but also run an approximation algorithm, such as iterated descent, with each subsequent event. The processing pipeline may then, on query, compute aggregate statistics for groups of students or groups of problems.

In some examples, processing pipelines are constrained based on the order (e.g., in order, partially in order, or out of order) that they must process learning events. For example, certain systems keep track of when students are online and have a data structure with a boolean indicator for each five minute period for each student. For example, the processing pipeline maintains a two-dimensional array, with one dimension as students, and the other, as times in five-minute increments. This would likely stored in a sparse format, such as a list of times, or run length encoded. This is initialized to zero. If a packet comes for a student with a given timestamp, the corresponding entry in the data structure is set to True. The packets may be processed in any order and out-of-order. Likewise, basic single-dimensional item response theory for simple single-attempt can generally be computed with problem submissions in any order. Another example of an order constrained processing pipeline includes a processing pipeline which keeps track of what segments of video a student watched. Such a processing pipeline benefits from having such information arrive in order, so it can correlate start/stop times without global accesses. However, sessions may come out-of-order (e.g. if a student is watching videos on a mobile device and a desktop device). Other examples of an order constrained processing pipelines include temporal algorithms, such as Bayesian Knowledge Tracing.

Yet other processing pipelines may require different subsets of events, and may be able to shard across different sets of events. For example a video histogram pipeline may only require video events, and would be shardable on a per-resource basis. In another example, an analytics subsystem showing when a user is online would require that events entering the pipeline are filtered, and then multiplexed to multiple event handlers for analytics processing. Different event handlers may have different computational requirements, require different subsets of data, have different requirements for how non-sequential data is handled, and have different latency requirements. Learning events are filtered and routed to such pipelines.

In some examples, different processing pipelines have differing computation and storage complexity constraints. For example, some processing pipelines require an expensive global optimization and may be more efficiently computed in bulk, either periodically (e.g. hourly), on request (e.g. when an instructor requests an analytic), or after some batch of events (e.g. every thousand events, unless such would require) while some processing pipelines process learning events exactly or approximately in a streaming fashion, event-by-event with similar computational demands.

Some processing pipelines are capable of forming and using data snapshots. For example, a processing pipeline can periodically snapshot the state of the pipeline. When a bulk download from e.g. a previously off-line device comes it, it may reprocess data, and then continue computing incrementally. Of course, for other processing pipelines, this reprocessing behavior may be computationally or storage prohibitive.

Another constraint that may be placed on processing pipelines is a reliability constraint. For example, a processing pipeline that handles high stakes tasks (e.g., grading) can not be allowed to lose or not process any learning events. On the other hand, a processing pipeline that handles low stakes tasks, such as peering students or computing aggregate instructor analytics over all students, may be allowed to lose some events since doing so only has a limited impact on system performance.

In order to accommodate the various different requirements of processing pipelines, the learning event processor 121 presents a configurable outline for defining processing pipelines and event handlers. The event processing system consists of a set of event pipelines. Depending on implementation, these may be:
a. Composed of a set of pipelines preconfigured in code, where each pipeline is custom-developed. For example, a system might have one pipeline for nightly, batch operations, using Hadoop, and a second for stream processing created as events coming in as regular web requests in a database-backed applications. This is the preferred implementation for systems at our scale.
b. Composed from components using pluggable technologies such as Apache Storm, based on requirements of particular event systems. The developer may provide a set of components (e.g. for batching), and the system administrator may configure them.
c. Dynamically created based on the set of event processors in the system. The system may analyze the set of event handlers, their requirements, and create a pipeline that is some approximation of optimal for those requirements. For example, if two stream handlers need events filtered in the same way, such a system would combine the two.

An event handler may advertise its requirements to the analytics systems. A prefered method of doing this is using Python decorators. For example, an event handler may be advertised as:

```
@event_handler(
      shard = PER_STUDENT,
      reliability = NICE_TO_HAVE,
      response_time = SECONDS,
      event_set = [{“event_type” : “video”}],
      batch = None,
      complexity = FAST_SERIAL,
      ordering = OUT_OF_ORDER
      )
def video_progress(events):
      # Logic to process events
```

The example event handler above is an event handler computers a learning analytic which tracks what portions of a video a student has viewed, as may be used for helping students visualize and track progress, and find the next activity to engage in. In this case, the shard parameter specifies that this may be run on independent machines or data storage back-ends on a per-student basis (as opposed to, for instance, no sharding possible for a global optimization, or a per-resource sharding for statistics about usage of a given video).

As an auxiliary analytic, reliability is set to a low level (NICE_TO_HAVE). If a student incorrectly sees a viewed video as unviewed, it is not a critical failure. event set has a filter query for types of events seen—in this case, only events with the event type field set to video. For purposes of illustration, we assume events are in JSON format (edX, Caliper, and xAPI all use JSON-seq or variants there-of), and that the search query uses the Mongo query language over such events (and the decorator takes a list of such queries). response_time may be set to IN_REQUEST (typically, <30 ms), HUMAN_RESPONSE_TIME (sub-second), SECONDS, MINUTES, HOURS, DAILY, WEEKLY, MONTHLY, PER_RUN, SYNC_REQUEST (on-demand when an user requests, shown immediately), ASYNC_REQUEST (user requests results, which stars a computational process, and results are returned once such computation is completed), or otherwise. batch specifies that there is minimal advantage to sending events in bulk.

Otherwise, it might specify a limit on how many events to queue before calling the event handler, or a timeout on how long to hold them, or both (and, obviously, the analytics pipeline may not honor this if e.g. a machine is idle). complexity specifies that the system is has fast (<10 ms) response time, even if events are not batched. ordering specifies the system can handle events in any order. Otherwise, it might specify that events must be ordered, or specific constraint on ordering, such as that events must be ordered e.g. on a per-resource basis. In such a case, it may also specify a strategy for how to manage this, and how to manage off-line events. For example, it might specify that if an out-of-order event comes in, all events since that event must be replied.

As alternative implementations, this may be specified by a configuration file on disk (for example, in a language such as YAML, XML, or JSON), in a database, or hardcoded.

Where events are on a mobile device, event preprocessors may also be placed on the mobile device. In such a way, computation is offloaded from the server to the client, reducing server costs. In addition, the software on the mobile device will have access to some analytics data even while offline. Such analytics processors may be implemented in JavaScript. In such a way, new analytics processors may be sent from the server to the client without an app update.

### Implementations

Systems that implement the techniques described above can be implemented in software, in firmware, in digital electronic circuitry, or in computer hardware, or in combinations of them. The system can include a computer program product tangibly embodied in a machine-readable storage device for execution by a programmable processor, and method steps can be performed by a programmable processor executing a program of instructions to perform functions by operating on input data and generating output. The system can be implemented in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data recordings; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

It is to be understood that the foregoing description is intended to illustrate and not to limit the scope of the invention, which is defined by the scope of the appended claims. Other embodiments are within the scope of the following claims.

What is claimed is:

1. A method for processing learning events in a learning management system, the method comprising:
receiving a plurality of learning events at the learning management system,
processing the plurality of learning events in a plurality of processing pipelines to generate learning analytics, wherein at least some of the processing pipelines are configured according to one or more processing constraints, the processing constraints including one or more of temporal constraints, learning event ordering constraints, and computational resource constraints; and
adjusting a behavior of the learning management system based on the generated learning analytics.

2. The method of claim 1 wherein at least some of the learning events are received out of order.

3. The method of claim 2 wherein a processing pipeline of the plurality of processing pipelines processes the at least some of the learning events in the order in which they are received.

4. The method of claim 2 wherein a processing pipeline of the plurality of processing pipelines processes reorders the at least some of the learning events prior to processing the at least some of the learning events.

5. The method of claim 4 wherein the reordering includes waiting for missing messages to be received.

6. The method of claim 1 wherein the computational resource constraints specify that received learning events are provided to different processing pipelines of the plurality of processing pipelines based on expected computational requirements associated with the learning events.

7. The method of claim 1 wherein the computational resource constraints specify that the received learning events are provided to different processing pipelines of the plurality of processing pipelines based on a computational load of the processing pipelines.

8. The method of claim 1 wherein the one or more temporal constraints specify that at least some of the processing pipelines execute periodically.

9. The method of claim 1 wherein the one or more temporal constraints specify that at least some of the processing pipelines execute on request.

10. The method of claim 1 wherein at least some of the processing pipelines execute when a predetermined number of learning events are received at the processing pipelines.

11. The method of claim 1 wherein at least some of the processing pipelines process learning events immediately upon arrival of the learning events.

12. The method of claim 1 wherein at least some of the processing pipelines are associated with a reliability constraint.

13. The method of claim 12 wherein the reliability constraint specifies a number of learning events that can be left unprocessed by the at least some processing pipelines.

14. A method for processing learning events in a learning management system, the learning events being transmitted from a plurality of user devices to the learning management system, at least some of the user devices having intermittent connectivity to the learning management system, the method comprising:
receiving the learning events at the learning event management system, wherein at least some of the learning events were aggregated by a user device while the user device was disconnected from the learning management system and were subsequently transmitted to the learning management system when the user device re-established connectivity with the learning management system;
updating one or more learning analytics models associated with the learning management system based on the received learning events, including updating at least some of the one or more learning analytics models based at least in part on the at least some of the learning events that were aggregated by a user device while the user device was disconnected from the learning management system and were subsequently transmitted to the learning management system when the user device re-established connectivity with the learning management system.
